(19) United States
(12) Patent Application Publication
(10) Pub. No.: US 2010/0322595 A1
(43) Pub. Date: Dec. 23, 2010

(54) DIGITAL AV DEVICE, SETTING DATA COPY JIG, AND SETTING DATA COPY METHOD

(75) Inventors: Yutaka Kitamori, Kadoma City (JP); Ryota Nakamura, Miyakonojo City (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi City (JP)

(21) Appl. No.: 12/795,033

(22) Filed: Jun. 7, 2010

(30) Foreign Application Priority Data
Jun. 17, 2009 (JP) 2009-144416

(51) Int. Cl. H04N 7/26

(52) U.S. Cl. 386/279; 386/E05.001

(57) ABSTRACT

A setting data copy method includes: HDMI-connecting a copy source digital AV device and a copy destination digital AV device of the same type as a type of the copy source digital AV device; sending, by the copy source digital AV device, at least part of setting data of the copy source digital AV device to the copy destination digital AV device by using a CEC command; and updating, by the copy destination digital AV device, setting data of the copy destination digital AV device based on the at least part of the setting data received from the copy source digital AV device.

This nonprovisional application claims priority under 35 U.S.C. §119(a) on Patent Application No. 2009-144416 filed in Japan on Jun. 17, 2009, the entire contents of which are hereby incorporated by reference.

### BACKGROUND OF THE INVENTION

1. Field of the Invention

The present invention relates to a digital audiovisual (AV) device, a setting data copy jig for copying setting data of a digital AV device, and a setting data copy method of copying setting data of a digital AV device.

2. Description of the Related Art

A high-definition multimedia interface (HDMI), which is a digital interface for digital AV devices, allows high-speed transfer of audiovisual data via a single cable. Modern digital AV devices, such as flat television sets and DVD recorders, are increasingly equipped with HDMI terminals as a standard feature.

Connection between digital AV devices having HDMI terminals is achieved via an HDMI cable, which includes a first signal line to a fifth signal line described below.

The first signal line is a transition minimized differential signaling (TMDS) data signal line for one-way transmission of audiovisual data (hereinafter, referred to as AV data) and of InfoFrames (information on the format of AV data, etc.) from a source device to a sink device in a TMDS format.

The second signal line is a hot plug detect (HPD) signal line mainly used for specifying a timing of the start of transmission of AV data from the source device to the sink device.

The third signal line is a display data channel (DDC) signal line used for transmitting sink-device specific information (vendor name, model number, allowed resolution, HDMI terminal numbers, etc.) to the source device. The DDC signal line is also used for authentication conforming to the high-bandwidth digital content protection (HDCP). When the HDMI cable is connected to the HDMI terminal of the sink device, the DDC signal line is connected to a non-volatile random access memory (NVRAM) inside the sink device.

The fourth signal line is a DDC5V signal line for supplying electric power of 5 V from the source device to the sink device. The sink device has a hardware configuration in which, after the sink device is supplied with electric power of 5 V via the fourth signal line from the source device, the sink device outputs an HPD signal of 5 V to an HPD pin of the HDMI terminal.

The fifth signal line is a consumer electronics control (CEC) signal line used for implementing a CEC function.

The CEC function is a function that enables two-way control between the source device and the sink device, and is defined, along with AV data output specifications, in the HDMI standard. Nowadays, many CEC-compatible electronic devices are commercially available. The CEC function allows two-way exchange of commands between the source device and the sink device, and hence allows both one-to-one and one-to-many control of devices.

The CEC standard defines a variety of functions. For example, with the function “One Touch Play”, when the “Play” button is depressed on the source device (for example, DVD recorder), the sink device (for example, digital television set) automatically shifts from a stand-by mode, in which a power-save, idle state is maintained, to a power-on mode, in which a normal operation state is maintained, and selects as “input” the HDMI terminal connected via the HDMI cable to the source device. The CEC standard defines many other functions, and which functions to be implemented in products is up to manufacturers.

Incidentally, each digital AV device stores in its internal memory in a non-volatile manner setting data containing various kinds of setting values, such as a setting value on selectable channels, a setting value on video contrast, and a setting value on video brightness. The contents of the setting data correspond to so-called “settings of the digital AV device”.

For example, in a case of delivering television receivers to a hotel, with which guest rooms thereof are to be furnished, the lighting environment of each guest room, and view and operation restrictions for guests are different among hotels. Therefore, the vendor or service engineer needs to make appropriate settings for a large number (corresponding to the number of guest rooms) of television receivers for a hotel of delivery destination.

Specifically, such setting work is realized by two methods. One method is one-by-one manual setting for a large number of television receivers. The other method is performed as follows. That is, one of the television receivers is set manually, setting data read from the television receiver with its manual setting completed is written into an external memory such as an SD memory, and then, the setting data is copied to the other television receivers via the external memory.

However, the former method, that is, the one-by-one manual setting for a large number of television receivers may involve human errors.

With the latter method, that is, the method of setting one of the television receivers manually, writing setting data read from the television receiver with its manual setting completed, into an external memory such as an SD memory, and then copying the setting data to the other television receivers via the external memory, an interface for the external memory needs to be provided to the television receivers, which results in cost increase of the television receivers.

### SUMMARY OF THE INVENTION

The present invention has been made in view of the above-mentioned circumstances, and it is therefore an object of the present invention to provide a digital AV device, a setting data copy jig, and a setting data copy method, which are capable of reducing human errors in setting the digital AV device, and reducing cost of the digital AV device.

In order to achieve the above-mentioned object, a setting data copy method according to the present invention includes: HDMI-connecting a copy source digital AV device and a copy destination digital AV device of the same type as a type of the copy source digital AV device; sending, by the copy source digital AV device, at least part of setting data of the copy source digital AV device to the copy destination digital AV device by using a CEC command; and updating, by the copy destination digital AV device, setting data of the copy destination digital AV device based on the at least part of the setting data received from the copy source digital AV device.

Further, in order to achieve the above-mentioned object, another setting data copy method according to the present invention includes: HDMI-connecting a copy source digital AV device and a setting data copy jig; sending, by the copy source digital AV device, at least part of setting data of the copy source digital AV device to the setting data copy jig by using a CEC command; storing, by the setting data copy jig, the at least part of the setting data received from the copy source digital AV device; HDMI-connecting the setting data copy jig and a copy destination digital AV device of the same type as a type of the copy source digital AV device; sending, by the setting data copy jig, the at least part of the setting data stored in the setting data copy jig to the copy destination digital AV device by using another CEC command; and updating, by the copy destination digital AV device, setting data of the copy destination digital AV device based on the at least part of the setting data received from the setting data copy jig.

In order to achieve the above-mentioned object, a digital AV device according to the present invention includes: an HDMI interface; and a control portion that generates a CEC command for sending at least part of setting data of the digital AV device to a copy destination digital AV device of the same type as a type of the digital AV device, and outputs the generated CEC command to the HDMI interface.

In order to achieve the above-mentioned object, a setting data copy jig according to the present invention includes: an HDMI interface for receiving a CEC command from a digital AV device having the above-mentioned configuration; a storage portion that stores at least part of setting data of the digital AV device based on the CEC command received via the HDMI interface; and a control portion that generates another CEC command for sending the at least part of the setting data of the digital AV device stored in the storage portion to a copy destination digital AV device of the same type as a type of the digital AV device, and outputs the generated another CEC command to the HDMI interface.

### DESCRIPTION OF THE DRAWINGS

FIG. 1 is a diagram illustrating an example of HDMI connection between a television receiver of copy source of setting data and a television receiver of copy destination thereof.

FIG. 2 is a schematic diagram illustrating a configuration example of the television receiver.

FIG. 3 is a diagram illustrating how a message indicating that setting data copy is in progress is displayed using on-screen display (OSD).

FIG. 4 is a diagram illustrating how a message indicating that setting data copy is completed is displayed using the OSD.

FIG. 5 is a diagram illustrating an example of HDMI connection between the television receiver of copy source of setting data and a plurality of the television receivers of copy destination thereof.

FIG. 6 is a schematic diagram illustrating a configuration example of a setting data copy jig according to an embodiment of the present invention.

FIG. 7A is a diagram illustrating an example of HDMI connection between the setting data copy jig and the television receiver of copy source.

FIG. 7B is a diagram illustrating an example of HDMI connection between the setting data copy jig and the television receiver of copy destination.

### DESCRIPTION OF THE PREFERRED EMBODIMENTS

The present invention relates to a technology of copying setting data with the use of a CEC function of an HDMI among a plurality of digital AV devices of the same type. Embodiments of the present invention are described below with reference to the accompanying drawings. In the embodiments described below, a television receiver is taken as an example of the digital AV device.

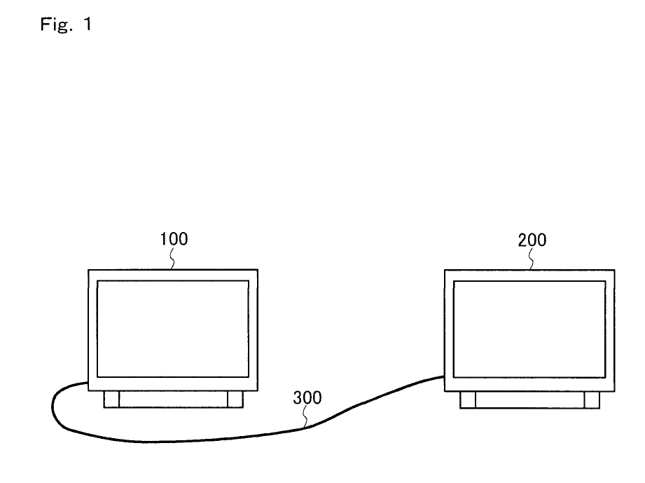

FIG. 1 is a diagram illustrating an example of HDMI connection between a television receiver of copy source of setting data and a television receiver of copy destination thereof. In the example of HDMI connection illustrated in FIG. 1, one copy source television receiver 100 and one copy destination television receiver 200 are connected to each other via an HDMI cable 300. Setting data contains various kinds of setting values such as a setting value on selectable channels, a setting value on video contrast, and a setting value on video brightness. It should be noted that the whole of the setting data may be copied between the television receivers, or part of the setting data may be copied therebetween.

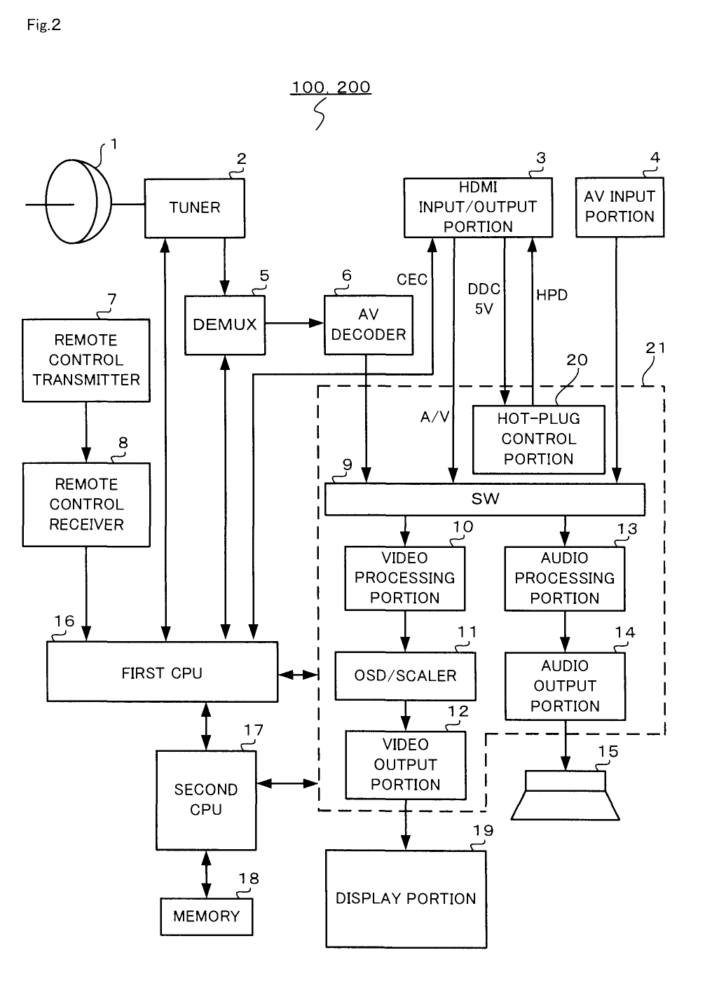

Described next is a configuration example of the copy source television receiver 100 and the copy destination television receiver 200, which is schematically illustrated in FIG. 2. The copy source television receiver 100 and the copy destination television receiver 200 each include a tuner 2, an HDMI input/output portion 3, an AV input portion 4, a demultiplexer (DEMUX) 5, an AV decoder 6, a remote control receiver 8, a switch 9, a video processing portion 10, an OSD/scaler 11, a video output portion 12, an audio processing portion 13, an audio output portion 14, a loudspeaker 15, a first central processing unit (CPU) 16, a second CPU 17, a memory 18, a display portion 19, and a hot-plug control portion 20.

An antenna 1 is installed outdoors, which receives a digital broadcast wave, and outputs a high-frequency digital modulated signal to the tuner 2.

The tuner 2 selects a physical channel in response to a channel select signal from the first CPU 16. Through this channel selection process, the tuner 2 converts the high-frequency digital modulated signal into a signal of a particular frequency. The tuner 2 also demodulates the selected digital modulated signal to generate a transport stream, and outputs the generated transport stream to the DEMUX 5.

The DEMUX 5 demultiplexes the transport stream received from the tuner 2 into a video stream, an audio stream, program specific information/service information (PSI/SI), and the like of the moving picture experts group 2 (MPEG-2).

The AV decoder 6 includes a video decoder (not shown) that decodes the video stream and an audio decoder (not shown) that decodes the audio stream, and outputs the decoded audiovisual information to the switch 9.

The HDMI input/output portion 3 has three HDMI terminals (not shown), to each of which an HDMI cable can be connected. Audiovisual information input from an external device via a TMDS data signal line of the HDMI cable to the HDMI input/output portion 3 is input to the switch 9. CEC pins of the three HDMI terminals are directly coupled together and connected to the first CPU 16, and hence CEC commands input from the external device via a CEC signal line of the HDMI cable to the HDMI input/output portion 3 are input to the first CPU 16. On the other hand, CEC commands output from the first CPU 16 to the HDMI input/output portion 3 are input via the CEC signal line of the HDMI cable to the external device.

In a case where the external device is a source device, electric power of 5 V is supplied from the external device via a DDC5V signal line of the HDMI cable and via the HDMI input/output portion 3 to the hot-plug control portion 20. Non-volatile random access memories (NVRAMs) (not shown) are provided to each of the HDMI terminals, and among the individually provided NVRAMs, only the NVRAM that corresponds to an HDMI terminal to which the HDMI cable is connected is supplied with electric power of 5 V from the external device via the DDC5V signal line of the HDMI cable and via the HDMI input/output portion 3. The hot-plug control portion 20 outputs a low-level or high-level control signal to the HDMI input/output portion 3, to thereby specify a timing of the start of transmission of AV data from the external device (source device) to a sink device.

On the other hand, in a case where the external device is a sink device, electric power of 5 V is supplied to the external device via the DDC5V signal line of the HDMI cable and via the HDMI input/output portion 3.

The AV input portion 4 has an S-terminal (not shown), a D-terminal (not shown), and an RCA terminal (not shown). Audiovisual information input from the external device via an S-terminal cable, a D-terminal cable, or an RCA-terminal cable to the AV input portion 4 is output to the switch 9.

The switch 9 is a switch for switching among the audiovisual inputs from the AV decoder 6, the HDMI input/output portion 3, and the AV input portion 4. The video processing portion 10 performs digital video processing on the video information input via the switch 9. The OSD/scaler 11 is a circuit that generates video data based on character information and color information specified by the second CPU 17, and performs reduction processing on received broadcast video. The OSD/scaler 11 enables display of an electronic program guide (EPG) based on broadcast program information, display of data broadcast, display of menu screens, and the like. The video output portion 12 converts the video information input from the OSD/scaler 11 into a format of an input signal to the display portion 19. The display portion 19 displays video based on the video signal input from the video output portion 12.

The audio processing portion 13 receives audio information via the switch 9, performs D/A conversion on the received audio information, and outputs the resulting analog audio signal to the audio output portion 14. The audio output portion 14 amplifies and processes the audio signal input from the audio processing portion 13, and outputs the resulting audio signal to the loudspeaker 15. The loudspeaker 15 reproduces sounds based on the audio signal input from the audio output portion 14.

A remote control transmitter 7 is a transmitter for transmitting instructions to the television receiver. When a key provided on the remote control transmitter 7 is operated, a remote control signal corresponding to the key is transmitted from a light-emitting portion of the remote control transmitter 7. The remote control receiver 8 receives the remote control signal, converts the received remote control signal into an electrical signal, and supplies the resulting signal to the first CPU 16.

The first CPU 16 mainly performs processing in response to remote control signals from the remote control transmitter 7 and signals resulting from key operation on an operation portion (not shown), and also controls the tuner 2 and the like. Even when the power is turned off (power-save mode is invoked) by the remote control transmitter 7, the first CPU 16 remains supplied with electric power and keeps operating to perform processing such as monitoring of remote control signals. On the other hand, the second CPU 17 mainly controls the OSD/scaler 11, the video processing portion 10, the display portion 19, and the like. The first CPU 16 and the second CPU 17 are configured so that they can communicate with each other, and hence, under the control of the first CPU 16, the second CPU 17 and the individual blocks in an audiovisual processing portion 21 can be stopped and started.

The memory 18 is a non-volatile memory, which stores control programs, setting data, and the like.

In a case where the copy source television receiver 100 outputs the whole or part of the setting data to an external device, the second CPU 17 of the copy source television receiver 100 reads from the memory 18 the whole or part of the setting data stored in the memory 18 as copy target data, and transfers the read data to the first CPU 16. The first CPU 16 uses a CEC command (vendor command) uniquely defined by a vendor to output the data transferred from the second CPU 17 to the CEC pin of the HDMI terminal provided to the HDMI input/output portion 3.

The vendor command used in the case where the copy source television receiver 100 outputs the whole or part of the setting data to the external device may be set in such a format as shown in Table 1 below.

TABLE 1

| Data | Content | Example |
|---|---|---|
| 1st byte | Address | 0x0F |
| 2nd byte | OP_Code | 0x89 |
| 3rd byte | Function notification | 0x10 |
| 4th byte | Set number of transmissions | 0x02 |
| 5th byte | Menu ID | 0x01 |
| 6th byte | Setting value | 0x02 |
| 7th byte | Menu ID | 0x04 |
| 8th byte | Setting value | 0x01 |

The “Address” in the first byte indicates communication from the copy source television receiver 100 (logical address 0) to a logical address F. The logical address F indicates all the connection destinations and hence includes the copy destination television receiver 200. The “OP_Code” in the second byte indicates that the command is a vendor-specific code. The third byte indicates a function notification (notification of a function of copying the whole or part of the setting data). The fourth byte indicates the number of transmissions of a pair of menu ID and setting value, which are indicated in the fifth and subsequent bytes. The fifth and subsequent bytes indicate on a two-byte basis a menu ID and a setting value regarding a menu identified by the menu ID. The menu ID is a number for identifying various kinds of menus such as selectable channels, video contrast, video brightness, and hotel mode settings (for enabling/disabling menu screen display and OSD).

In a case where the copy destination television receiver 200 receives from an external device the input of the whole or part of the setting data, on the other hand, the whole or part of the setting data received through the CEC signal line of the HDMI cable is sent to the first CPU 16 via the CEC pin of the HDMI terminal provided to the HDMI input/output portion 3 of the copy destination television receiver 200. The first CPU 16 transfers to the second CPU 17 the data sent via the CEC pin, and the second CPU 17 updates the setting data stored in the memory 18 based on the data transferred from the first CPU 16.

The function of copying the whole or part of the setting data is not intended for general users' use, and hence execution of the function of copying the whole or part of the setting data may be limited only to the case where a composite key (simultaneous operation of a plurality of specific keys) or a hidden menu is used.

After the copy source television receiver 100 and the copy destination television receiver 200 are connected to each other via the HDMI cable 300 as illustrated in FIG. 1, for example, the following procedure is taken to execute the function of copying the whole or part of the setting data.

(A1) The vendor or service engineer uses a composite key or a hidden menu on the copy source television receiver 100 side, and then changes the mode of the copy source television receiver 100 to a setting data copy mode to give an instruction to start copying the whole or part of the setting data. When the composite key is used, a copy start instruction may directly be given with the use of the composite key, or alternatively, the composite key may cause a hidden menu to appear and the copy start instruction may be given on the hidden menu.

(A2) The copy source television receiver 100 transmits to the copy destination television receiver 200 the vendor command in the format of Table 1 above.

(A3) The copy destination television receiver 200 receives the vendor command in the format of Table 1 above. The CEC is only capable of transmitting and receiving data up to 16 bytes by one command because of its specification. In general, 16-byte transmission does not allow the whole of the copy target data to be sent from the copy source television receiver 100 to the copy destination television receiver 200, and hence a plurality of vendor commands are issued to send the whole of the copy target data from the copy source television receiver 100 to the copy destination television receiver 200. The copy destination television receiver 200 determines the completion of the copy target data reception based on whether or not the vendor command contains a menu ID of “0xFF”.

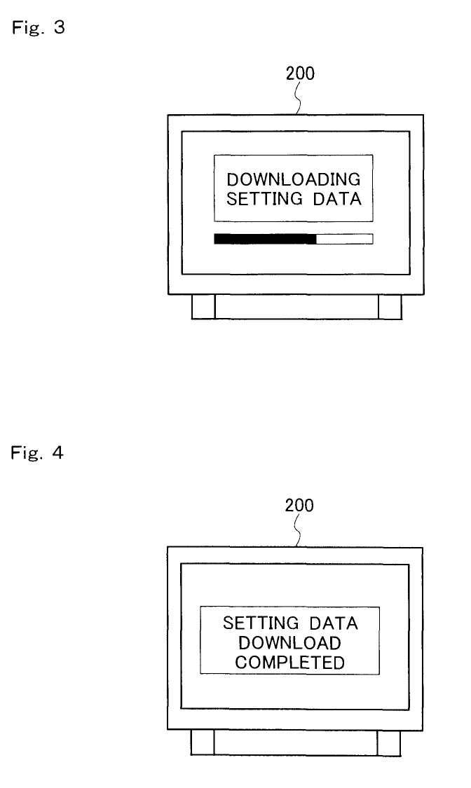

(A4) When the copy destination television receiver 200 receives the vendor command containing the menu ID of “0xFF”, the copy destination television receiver 200 updates the setting data stored in the memory 18 based on the vendor commands that have been received thus far. In the period from the start of reception of the vendor command in the format of Table 1 above until the completion of the update of the setting data stored in the memory 18, the copy destination television receiver 200 may cause the display portion 19 to display a message indicating that setting data copy is in progress, using OSD as illustrated in FIG. 3. Instead of the OSD, the copy destination television receiver 200 may turn on an LED provided thereto, for example, to indicate that setting data copy is in progress.

(A5) After the copy destination television receiver 200 has completed the update of the setting data stored in the memory 18, the copy destination television receiver 200 causes the display portion 19 to display for a predetermined period of time a message indicating that setting data copy is completed, using OSD as illustrated in FIG. 4. Instead of the OSD, the copy destination television receiver 200 may turn on the LED provided thereto, for example, to indicate that setting data copy is completed. The indication that setting data copy is in progress and the indication that setting data copy is completed may be distinguished from each other by colors of light emitted from the LED (for example, red and green), lighting manners (for example, blinking and always-on), or the like.

(A6) After the setting data copy has been completed, the vendor or service engineer powers off the copy source television receiver 100, for example, to terminate the setting data copy mode of the copy source television receiver 100.

In the above-mentioned procedure, the vendor or service engineer gives the instruction to start copying the whole or part of the setting data on the copy source television receiver 100 side, but alternatively, the vendor or service engineer may use a vendor command in a format of Table 2 below, for example, to give the instruction to start copying the whole or part of the setting data on the copy destination television receiver 200 side. In this case, for example, the processing (A1) of the above-mentioned procedure may be replaced with the following processing (A1′).

(A1′) The vendor or service engineer uses a composite key or a hidden menu on the copy source television receiver 100 side, and then changes the mode of the copy source television receiver 100 to a setting data copy mode to set the copy source television receiver 100 ready for copy. After that, the vendor or service engineer uses a composite key or a hidden menu on the copy destination television receiver 200 side, and then causes the copy destination television receiver 200 to transmit a copy start instruction command, for example, the vendor command in the format of Table 2 below.

TABLE 2

| Data | Content | Example |
|---|---|---|
| 1st byte | Address | 0x0F |
| 2nd byte | OP_Code | 0x89 |
| 3rd byte | Function inquiry | 0x11 |

The “Address” in the first byte indicates communication from the copy destination television receiver 200 (logical address 0) to the logical address F. The logical address F indicates all the connection destinations and hence includes the copy source television receiver 100. The “OP_Code” in the second byte indicates that the command is a vendor-specific code. The third byte indicates a function inquiry (inquiry of a function of copying the whole or part of the setting data).

With the above-mentioned setting data copy method, the CEC command allows the copy of the whole or part of the setting data, thereby reducing human errors. In addition, the above-mentioned setting data copy method does not necessitate an interface for an external memory for the copy source digital AV device (copy source television receiver 100) and for the copy destination digital AV device (copy destination television receiver 200), thereby reducing cost of the digital AV device.

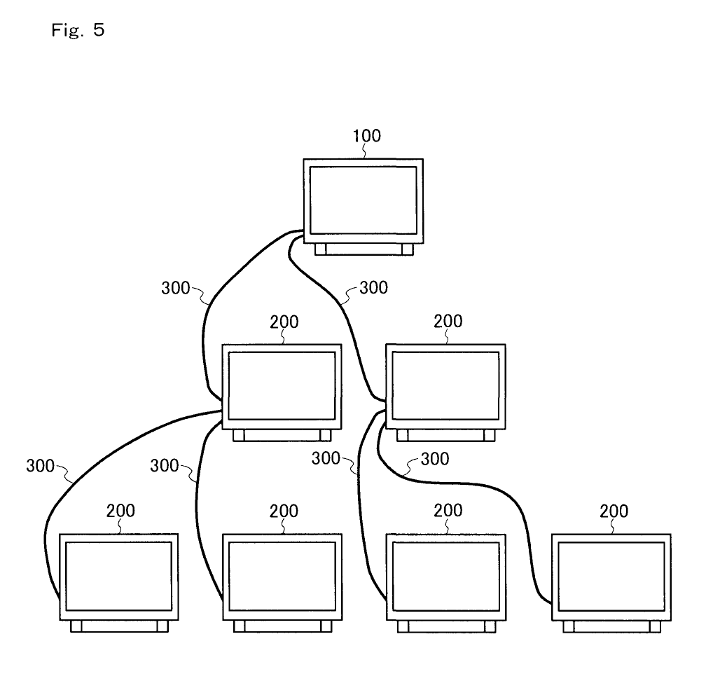

In the above-mentioned example of HDMI connection between the copy source television receiver 100 and the copy destination television receiver 200, which is illustrated in FIG. 1, one copy source television receiver 100 and one copy destination television receiver 200 are connected to each other. As described above, however, in the copy source television receiver 100 and the copy destination television receiver 200 each having the configuration illustrated in FIG. 2, the CEC pins of the three HDMI terminals of the HDMI input/output portion 3 are directly coupled together and connected to the first CPU 16. Therefore, as illustrated in FIG. 5, for example, a plurality of the HDMI cables 300 may be used for HDMI connection between the copy source television receiver 100 and a plurality of the copy destination television receivers 200, which consequently achieves simultaneous copy of the whole or part of the setting data to the plurality of the copy destination television receivers 200.

Further, in the above-mentioned examples of HDMI connection between the copy source television receiver 100 and the copy destination television receiver 200, which are illustrated in FIGS. 1 and 5, at the time of copying the whole or part of the setting data, the positional relationship between the copy source television receiver 100 and the copy destination television receiver 200 is limited by the total length of the HDMI cable 300. In view of this, a setting data copy jig may be used for eliminating such positional limitation.

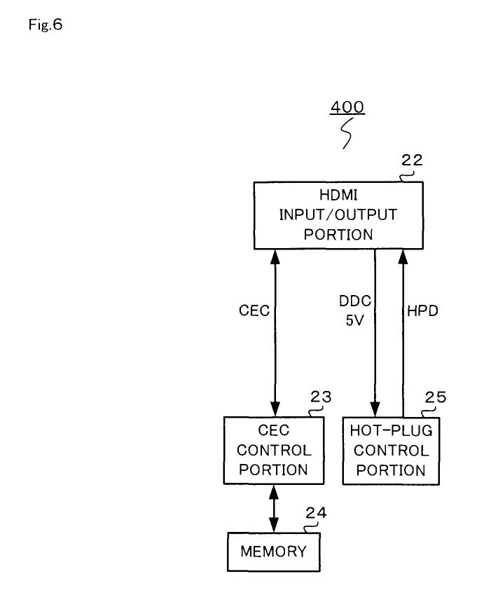

FIG. 6 schematically illustrates a configuration example of a setting data copy jig 400 according to an embodiment of the present invention. The setting data copy jig 400 includes an HDMI input/output portion 22, a CEC control portion 23, a memory 24, and a hot-plug control portion 25.

The HDMI input/output portion 22 has the same configuration as the HDMI input/output portion 3 of the copy source television receiver 100 and the copy destination television receiver 200. The hot-plug control portion 25 also has the same configuration as the hot-plug control portion 20 of the copy source television receiver 100 and the copy destination television receiver 200.

The CEC control portion 23 corresponds to the portion relating to the CEC control of the first CPU 16 and the second CPU 17 of the copy source television receiver 100 and the copy destination television receiver 200. The memory 24 stores a control program relating to the CEC control, and can store the whole or part of the setting data sent from the copy source television receiver 100.

Hereinbelow, description is given of an example of a procedure of copying the whole or part of the setting data with the use of the setting data copy jig 400.

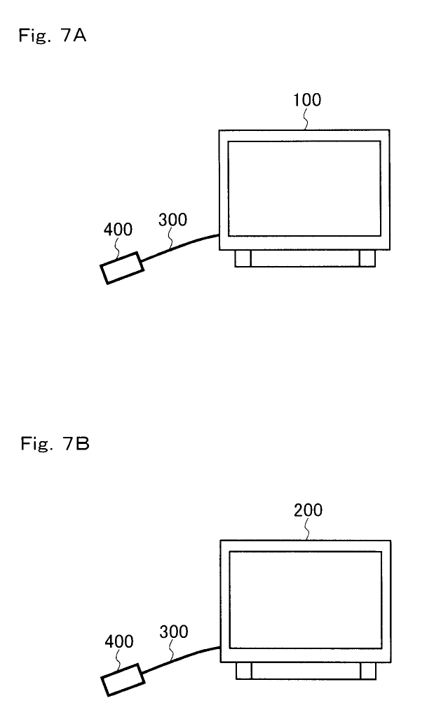

(B1) As illustrated in FIG. 7A, after the vendor or service engineer connects the copy source television receiver 100 and the setting data copy jig 400 via the HDMI cable 300, the vendor or service engineer uses a composite key or a hidden menu on the copy source television receiver 100 side, and then changes the mode of the copy source television receiver 100 to a setting data copy mode to give an instruction to start copying the whole or part of the setting data. When the composite key is used, a copy start instruction may directly be given with the use of the composite key, or alternatively, the composite key may cause a hidden menu to appear and the copy start instruction may be given on the hidden menu.

(B2) The copy source television receiver 100 transmits to the setting data copy jig 400 the vendor command in the format of Table 1 above.

(B3) The setting data copy jig 400 receives the vendor command in the format of Table 1 above. The CEC is only capable of transmitting and receiving data up to 16 bytes by one command because of its specification. In general, 16-byte transmission does not allow the whole of the copy target data to be sent from the copy source television receiver 100 to the setting data copy jig 400, and hence a plurality of vendor commands are issued to send the whole of the copy target data from the copy source television receiver 100 to the setting data copy jig 400. The setting data copy jig 400 determines the completion of the copy target data reception based on whether or not the vendor command contains a menu ID of “0xFF”.

(B4) When the setting data copy jig 400 receives the vendor command containing the menu ID of “0xFF”, the setting data copy jig 400 stores the whole or part of the setting data in the memory 24 based on the vendor commands that have been received thus far (if the whole or part of the setting data has already been stored, the setting data copy jig 400 updates the setting data). It should be noted that the following indications may be made by, for example, providing an LED to the setting data copy jig 400. In the period from the start of reception of the vendor command in the format of Table 1 above until the completion of the data writing in the memory 24, the setting data copy jig 400 may turn on the LED to indicate that setting data copy is in progress. After the data writing in the memory 24 has been completed, the setting data copy jig 400 turns on the LED for a predetermined period of time to indicate that setting data copy is completed. The indication that setting data copy is in progress and the indication that setting data copy is completed may be distinguished from each other by colors of light emitted from the LED (for example, red and green), lighting manners (for example, blinking and always-on), or the like.

(B5) After the completion of the setting data copy from the copy source television receiver 100 to the setting data copy jig 400, the vendor or service engineer powers off the copy source television receiver 100, for example, to terminate the setting data copy mode of the copy source television receiver 100. Then, as illustrated in FIG. 7B, after the vendor or service engineer connects the setting data copy jig 400 and the copy destination television receiver 200 via the HDMI cable 300, the vendor or service engineer uses a key (not shown) provided to the setting data copy jig 400 to give the setting data copy jig 400 an instruction to start copying the whole or part of the setting data.

(B6) The setting data copy jig 400 transmits to the copy destination television receiver 200 the vendor command in the format of Table 1 above.

(B7) The copy destination television receiver 200 receives the vendor command in the format of Table 1 above. The CEC is only capable of transmitting and receiving data up to 16 bytes by one command because of its specification. In general, 16-byte transmission does not allow the whole of the copy target data to be sent from the setting data copy jig 400 to the copy destination television receiver 200, and hence a plurality of vendor commands are issued to send the whole of the copy target data from the setting data copy jig 400 to the copy destination television receiver 200. The copy destination television receiver 200 determines the completion of the copy target data reception based on whether or not the vendor command contains a menu ID of “0xFF”.

(B8) When the copy destination television receiver 200 receives the vendor command containing the menu ID of “0xFF”, the copy destination television receiver 200 updates the setting data stored in the memory 18 based on the vendor commands that have been received thus far. In the period from the start of reception of the vendor command in the format of Table 1 above until the completion of the update of the setting data stored in the memory 18, the copy destination television receiver 200 may cause the display portion 19 to display a message indicating that setting data copy is in progress, using OSD as illustrated in FIG. 3. Instead of the OSD, the copy destination television receiver 200 may turn on an LED provided thereto, for example, to indicate that setting data copy is in progress.

(B9) After the copy destination television receiver 200 has completed the update of the setting data stored in the memory 18, the copy destination television receiver 200 causes the display portion 19 to display for a predetermined period of time a message indicating that setting data copy is completed, using OSD as illustrated in FIG. 4. Instead of the OSD, the copy destination television receiver 200 may turn on the LED provided thereto, for example, to indicate that setting data copy is completed. The indication that setting data copy is in progress and the indication that setting data copy is completed may be distinguished from each other by colors of light emitted from the LED (for example, red and green), lighting manners (for example, blinking and always-on), or the like.

In the above-mentioned procedure, the vendor or service engineer gives on the copy source television receiver 100 side the instruction to start copying the whole or part of the setting data from the copy source television receiver 100 to the setting data copy jig 400, but alternatively, the vendor or service engineer may use the vendor command in the format of Table 2 above, for example, to give the instruction to start copying the whole or part of the setting data on the setting data copy jig 400 side. In this case, for example, the vendor or service engineer may use a key (not shown) provided to the setting data copy jig 400 to give the copy start instruction.

Further, in the above-mentioned procedure, the vendor or service engineer gives on the setting data copy jig 400 side the instruction to start copying the whole or part of the setting data from the setting data copy jig 400 to the copy destination television receiver 200, but alternatively, the vendor or service engineer may use the vendor command in the format of Table 2 above, for example, to give the instruction to start copying the whole or part of the setting data on the copy destination television receiver 200 side.

With the setting data copy method using the above-mentioned setting data copy jig, the CEC command allows the copy of the whole or part of the setting data, thereby reducing human errors. In addition, the setting data copy method using the above-mentioned setting data copy jig does not necessitate an interface for an external memory for the copy source digital AV device (copy source television receiver 100) and for the copy destination digital AV device (copy destination television receiver 200), thereby reducing cost of the digital AV device.

The embodiments of the present invention have been described above, but the scope of the present invention is not limited thereto, and various modifications may be made to embody the present invention without departing from the gist of the present invention. For example, the shape of the HDMI terminal of the HDMI input/output portion 22 may be changed so that the HDMI input/output portion 3 and the HDMI input/output portion 22 can directly be connected to each other.

What is claimed is:

1. A setting data copy method, comprising:
HDMI-connecting a copy source digital AV device and a copy destination digital AV device of the same type as a type of the copy source digital AV device;
sending, by the copy source digital AV device, at least part of setting data of the copy source digital AV device to the copy destination digital AV device by using a CEC command; and
updating, by the copy destination digital AV device, setting data of the copy destination digital AV device based on the at least part of the setting data received from the copy source digital AV device.

2. A setting data copy method, comprising:
HDMI-connecting a copy source digital AV device and a setting data copy jig;
sending, by the copy source digital AV device, at least part of setting data of the copy source digital AV device to the setting data copy jig by using a CEC command;
storing, by the setting data copy jig, the at least part of the setting data received from the copy source digital AV device;
HDMI-connecting the setting data copy jig and a copy destination digital AV device of the same type as a type of the copy source digital AV device;
sending, by the setting data copy jig, the at least part of the setting data stored in the setting data copy jig to the copy destination digital AV device by using another CEC command; and
updating, by the copy destination digital AV device, setting data of the copy destination digital AV device based on the at least part of the setting data received from the setting data copy jig.

3. A digital AV device, comprising:
an HDMI interface; and
a control portion that generates a CEC command for sending at least part of setting data of the digital AV device to a copy destination digital AV device of the same type as a type of the digital AV device, and outputs the generated CEC command to the HDMI interface.

4. A digital AV device according to claim 3, wherein:
the HDMI interface comprises a plurality of HDMI terminals; and
the plurality of HDMI terminals comprise CEC pins which are directly coupled together and connected to the control portion.

5. A digital AV device according to claim 3, which is used as a television receiver.

6. A digital AV device according to claim 4, which is used as a television receiver.

7. A setting data copy jig, comprising:
a first HDMI interface for receiving a CEC command from a digital AV device;
a storage portion that stores at least part of setting data of the digital AV device based on the CEC command received via the first HDMI interface; and
a control portion that generates another CEC command for sending the at least part of the setting data of the digital AV device, which is stored in the storage portion, to a copy destination digital AV device of the same type as a type of the digital AV device, and outputs the generated another CEC command to the first HDMI interface,
wherein the digital AV device comprises:
a second HDMI interface; and
a control portion that generates the CEC command for sending the at least part of the setting data of the digital AV device to the copy destination digital AV device of the same type as the type of the digital AV device, and outputs the generated CEC command to the second HDMI interface.
